(19) United States
(12) Patent Application Publication
(10) Pub. No.: US 2024/0226833 A1
(43) Pub. Date: Jul. 11, 2024

(54) AERATING BLENDER

(71) Applicant: UNIVERSITY OF SOUTH CAROLINA, COLUMBIA, SC (US)

(72) Inventors: JOHN R. REGALBUTO, COLUMBIA, SC (US); JOHN A. REGALBUTO, TRAVERSE CITY, MI (US)

(21) Appl. No.: 18/403,140

(22) Filed: Jan. 3, 2024

Related U.S. Application Data
(60) Provisional application No. 63/600,260, filed on Nov. 17, 2023.
(60) Provisional application No. 63/438,059, filed on Jan. 10, 2023.

(51) Int. Cl. B01F 35/00; B01F 27/07; B01F 35/32; B01F 35/33; B01F 27/191; B01F 27/2121

(52) U.S. Cl. CPC B01F 35/56; B01F 27/074; B01F 35/3231; B01F 35/332; B01F 27/191; B01F 27/2121; B01F 35/3204

(57) ABSTRACT

A mixer for mixing contents of a vessel includes a rotational mechanism with an attached gearbox. First and second shafts are coaxial with each other and attached to the gearbox. The gearbox is configured to rotate the first shaft and the second shaft in opposite directions. First and second rotors are rotated, respectively, in opposite directions by the first and second shafts. A housing encloses the gearbox and extends downward from the gearbox to just above the two contra-rotating first and second rotors (or impellers). The housing directs air (or other gas, liquid, or fluid) downward. Openings at the top of the housing admit air which is forced to the bottom of the housing by additional air impellers fastened to the outer of the two shafts. Lower housing openings allow aerated air to exit into desired material, such as fluid or solid/liquid mixture.

### PRIORITY CLAIM

The present application claims the benefit of priority of U.S. Provisional Patent Application No. 63/438,059, filed Jan. 10, 2023, and the benefit of priority of U.S. Provisional Patent Application No. 63/600,260, filed Nov. 17, 2023, both of which are titled AERATING BLENDER, and both of which are fully incorporated herein by reference for all purposes.

### BACKGROUND OF THE PRESENTLY DISCLOSED SUBJECT MATTER

Mixers, particularly single impeller mixers, may inadequately perform desired mixing tasks. For example, the mixture may take an excessively long time to fully form, or the mixture may lack desired homogeneity or lack desired levels of aeration. Such deficiencies may be particularly true and problematic in the case of materials for use, for example, in cooking, such as batters or other materials.

The presently disclosed subject matter generally addresses system and method for improved mixer technology, configured to mix the contents of a vessel.

More particularly, the presently disclosed subject matter relates to mixer technology capable of distributing in a very uniform and efficient manner well aerated air into material(s) to be mixed.

The presently disclosed mixing technology offers various advantages, for example, speed of mixing and aeration. Thus, in some instances, improved fluffy aerated food, for example, can be desirably provided.

### SUMMARY OF THE PRESENTLY DISCLOSED SUBJECT MATTER

The presently disclosed mixer apparatus and corresponding and/or associated methodology, generally addresses improved mixer technology.

Further, presently disclosed subject matter relates to improved mixing of contents of a vessel. More particularly, the presently disclosed subject matter relates to mixer technology capable of distributing in a very uniform and efficient manner well aerated air into material(s) to be mixed.

The presently disclosed subject matter in part relates to a device which can aerate and blend fluids or solid/liquid mixtures in a very short time and with greater homogeneity compared to common single impeller mixers.

A mixer for mixing contents of a vessel can include a rotational mechanism with an attached gearbox. First and second shafts may be coaxial with each other and attached to the gearbox. The gearbox may be configured to rotate the first shaft and the second shaft in opposite directions. First and second rotors may be rotated, respectively, in opposite directions by the first and second shafts. Exemplary embodiments of such first and second rotors and respective shafts are represented by contra-rotating blades of the mixer represented in U.S. Pat. No. 9,839,884, the complete disclosure of which is fully incorporated herein by reference and for all purposes.

For some presently disclosed embodiments, a housing may enclose the gearbox and extends downward from the gearbox to just above the two contra-rotating first and second rotors (or impellers). The housing directs air (or other gas or liquid) downward. Openings at the top of the housing admit air which is forced to the bottom of the housing by additional air impellers fastened to the outer of the two shafts. Lower housing openings allow aerated air to exit into desired material, such as fluid or solid/liquid mixture. The contra-rotating impellers of the mixer distribute the exiting air into the material being aerated in a very uniform and efficient manner.

An exemplary embodiment of presently disclosed subject matter relates to a mixer apparatus configured to mix the contents of an associated vessel. Such exemplary mixer apparatus preferably comprises a rotational mechanism; a gearbox attached to the rotational mechanism; at least one shaft configured for rotation by the gearbox; at least one rotor with at least one rotor blade, with the rotor arranged to be driven by the at least one shaft; and a housing enclosing the gearbox adjacent a proximal end of the housing and having a distal end extending towards the at least one rotor. Further, the housing preferably has at least one entry opening for air to be drawn into the housing, and has at least one exit opening for aerated air to exit the housing.

Another exemplary embodiment according to the presently disclosed subject matter relates to a mixer apparatus configured to mix the contents of an associated vessel, such exemplary mixer apparatus preferably comprising a rotational mechanism; a gearbox attached to the rotational mechanism; first and second shafts respectively attached to the gearbox with the gearbox configured to rotate the first and second shafts in respective opposite directions, and with the first and second shafts coaxial to each other and with the first shaft located at least partially inside said second shaft to form paired inner and outer shafts; a first rotor, comprising a plurality of first rotor blades, and configured to be rotated by the first shaft; a second rotor, comprising a plurality of second rotor blades, and configured to be rotated by the second shaft; a housing enclosing the gearbox adjacent a proximal end of the housing and having a distal end extending towards the first and second rotors; a plurality of fluid entry openings formed in the periphery of the housing and adjacent the gearbox; a plurality of fluid exit openings formed in the periphery of the housing and adjacent the rotors; and at least a pair of fluid impellers, attached to the outer of the two coaxial shafts, for rotation within the housing as the outer shaft is rotated, and located adjacent the plurality of fluid entry openings so that as the impellers are rotated, fluid is drawn into the housing through at least one of the fluid entry openings, and pushed along the interior of the housing and out at least one of the fluid exit openings as aerated fluid.

It is to be understood that the presently disclosed subject matter equally relates to associated and/or corresponding methodologies. One exemplary such method relates to methodology for a mixer configured to mix the contents of an associated vessel. Such methodology preferably comprises providing a rotational mechanism; providing at least one shaft configured for rotation by the rotational mechanism; providing at least one rotor with at least one rotor blade, with the rotor arranged to be driven by the at least one shaft; providing a housing enclosing a region adjacent a proximal end of the housing and having a distal end extending towards the at least one rotor; providing the housing with at least one entry opening for air to be drawn into the housing, and with at least one exit opening for aerated air to exit the housing; and controllably rotating the at least one shaft so that air is drawn into the housing through the at least one entry opening and aerated air is pushed out the at least one exit opening.

Other example aspects of the present disclosure are directed to systems, apparatus, tangible, non-transitory computer-readable media, user interfaces, memory devices, and electronic devices for mixer technology. To implement methodology and technology herewith, one or more processors may be provided, programmed to perform the steps and functions as called for by the presently disclosed subject matter, as will be understood by those of ordinary skill in the art.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates a side elevational view of a PRIOR ART mixer apparatus utilizing contra-rotating rotors, suitable for use in combination with exemplary embodiments of presently disclosed subject matter; and

FIG. 2 illustrates a cross-sectional view of an exemplary embodiment of presently disclosed mixer technology.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to improved mixer technology, configured to mix the contents of a vessel. In particular, such presently disclosed subject matter relates to mixer technology capable of distributing in a very uniform and efficient manner well aerated air into material(s) to be mixed.

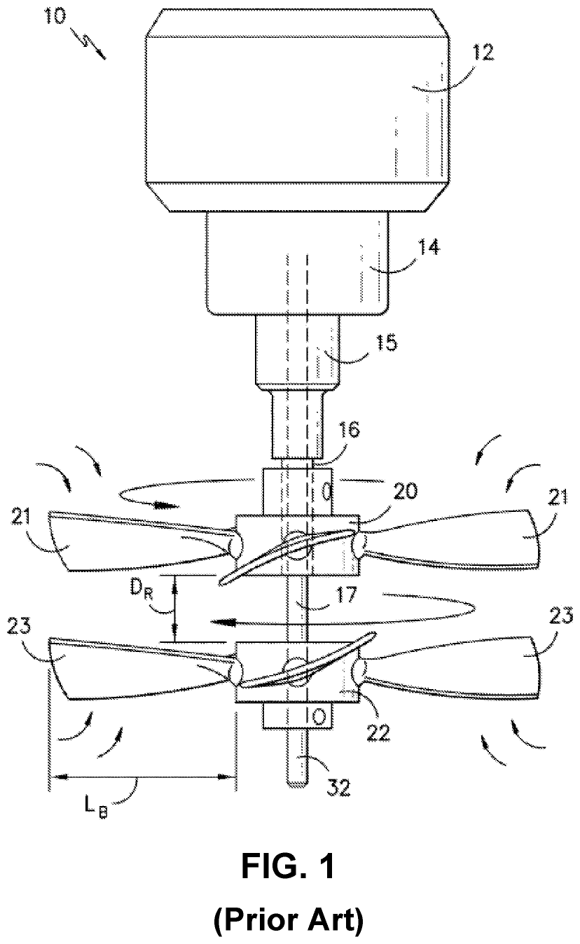

FIG. 1 illustrates a side elevational view of a PRIOR ART mixer apparatus utilizing contra-rotating rotors, such as shown in FIG. 1 of the herein-referenced U.S. Pat. No. 9,839,884. In particular, such contra-rotating rotors are one example of such rotors as would be suitable for use in combination with exemplary embodiments of presently disclosed subject matter. It is to be understood that other arrangements of contra-rotating rotors, such as shown or suggested by such U.S. Pat. No. 9,839,884, or elsewhere, may be practiced with specific embodiments of the presently disclosed subject matter. All such variations are intended to come within the spirit and scope of the presently disclosed subject matter.

FIG. 1 shows one particular embodiment of a prior art mixer apparatus 10. The mixer apparatus 10 generally includes a motor 12 (such as an electric motor, as the rotational mechanism) and a pair of gearboxes 14, 15. The gearboxes 14, 15 are coupled to a pair of coaxial shafts 16, 17. As shown, the outer shaft 16 defines a hollow center 18 where the inner shaft 17 is located. Thus, the inner shaft 17 is independently rotatable within the hollow center (dotted line) of the outer shaft 16. A lubricant (e.g., grease) can be included within the hollow center of the outer shaft 16 to ensure minimal friction between the coaxial shafts 16, 17 during operation. As such, the inner shaft 17 can rotate opposite to the outer shaft 16 (for example, with one shaft rotating clockwise and the other shaft rotating counter-clockwise).

Although represented as having two gearboxes 14, 15 in the embodiment of FIG. 1, a single gearbox can be utilized to rotate the inner shaft 17 and the outer shaft 16 in opposite directions. See, for example, FIG. 5 of incorporated U.S. Pat. No. 9,839,884, showing a single gearbox. In addition, the present disclosure encompasses alternatives, such as the alternative of using two separate motors spinning in opposite directions, with no gearbox, to produce contrarotation of nested axles.

No matter the particular configuration of the gearbox (or alternative feature(s)), each of the shafts 16, 17 are coupled to an exemplary rotor 20, 22, respectively. Due to the counter-rotation of the shafts 16, 17, the rotors 20, 22 are configured to rotate in opposite directions (i.e., contra-rotating). The rotors 20, 22 are shown vertically arranged, with the upper rotor 20 positioned closest to the gearboxes 14, 15 and above the lower rotor 22.

The rotors 20, 22 are connected to a plurality of rotor blades 21, 23, respectively. Although shown having four rotor blades 21, 23, any suitable number of rotor blades 21, 23 can be attached to the rotors 20, 22 (e.g., about two blades to about eight blades). The rotor blades 21, 23 can be curved and/or angled to help force the contents of the vessel in the direction desired. As shown, the rotors 20, 22 with the rotor blades 21, 23 can be described as a propeller. In another embodiment, the rotors 20, 22 with the rotor blades 21, 23 can be an impeller with a casing (not shown) surrounding the outer edges of the rotor blades 21, 23.

The rotational speed of each rotor 20, 22 (and their rotor blades 21, 23) and the speed ratio between the two rotors 20, 22 can be controlled to create the desired mixing motion of the contents of the vessel. For example, in one embodiment, the rotors 20, 22 are rotating at the same speed, but in opposite directions. In this embodiment, if the rotors 20, 22 and blades 21, 23 are substantially the same size, the contra-rotating rotors 20, 22 can serve to substantially eliminate torque applied to the contents/vessel during use. In alternative embodiments, the rotors 20, 22 are rotating at differing speeds and in opposite directions.

In the embodiment of FIG. 1, the angle of the blades and/or rotation direction of the upper rotor are such that the contents of the vessel are directed downward (toward the lower rotor), while the angle of the blades and/or rotation direction of the lower rotor are such that the contents are directed upward (toward the upper rotor). Thus, in this embodiment, the rotors are configured to direct the contents toward each other.

Additional variables are associated with any given implementation of the rotor blades 21, 23 and can be adjusted as understood by those of ordinary skill in the art without further explanation to achieve the desired mixing motion of the contents of the vessel, such as their angle, their cross-sectional shape, their aspect ratio, etc. Likewise, the solidity (defined as the ratio of the total projected area of the blades 21, 23 divided by the area swept by the rotor 20, 22/blades 21, 23) of the rotors 20, 22 can be controlled as desired. The spacing between the upper rotor 20 and the lower rotor 22 can also be adjusted as desired.

Also in this embodiment, an extension 32 can be positioned below the lower rotor 22 such that the lower rotor 22 is protected from contacting the bottom surface of an associated vessel. Although not shown, a casing can be positioned around the ends of the rotor blades 21, 23 and attached to the mixing apparatus 12 to prevent the edges of the blades 21, 23 from contacting the inner surface of the associated vessel. The length of the shafts 16, 17, measured from the gearboxes 14, 15 to the upper rotor 20, can be any suitable length depending on the size of the associated vessel and the depth of its contents. Generally, however, the shaft length can be greater than the average length L_{B} of the rotor blades 21 and/or 23 in most embodiments.

While the above-described technology of a contra-rotating mixer is much more effective than common single-impeller mixers for mixing liquids such as eggs or liquid-solid mixtures such as pancake batter, the presently disclosed technology has added the capacity of aerating the liquid or solid-liquid mixture. It is to be understood from the complete disclosure herewith that the present disclosure also encompasses adding the presently disclosed capacity of aerating the liquid or solid-liquid mixture in combination with single-impeller mixers also. Resulting further advantages from all the various embodiments disclosure herewith include such as speed of mixing and aeration. Fluffy aerated foodstuffs are, for example, in some cases desirable.

Various additional aspects are involved with further features disclosed herewith. For example, the presently disclosed subject matter can in some embodiments include an air impeller (fan/propeller) secured to the outer rotating shaft of a contra-rotating mechanism. Further, for some such embodiments, a close-fitting housing may enclose the contra-rotating mechanism and direct air (or other gas or liquid) downward. Such a housing in some instances extends from the differential gearbox to slightly above the two contra-rotating impellers. Openings at the top of the housing admits air which is forced to the bottom of the housing by the air impellers fastened to the outer shaft of the contra-rotating mechanism.

Openings in the lower portion of the housing allows air to exit into the material (fluid or solid/liquid mixture). The air impeller produces an air pressure at the lower exit openings greater than the hydraulic pressure at the outer surfaces of the exit opening of the housing. The contra-rotating impellers of the mixer distribute such exiting air into the material being aerated in a very uniform and efficient manner.

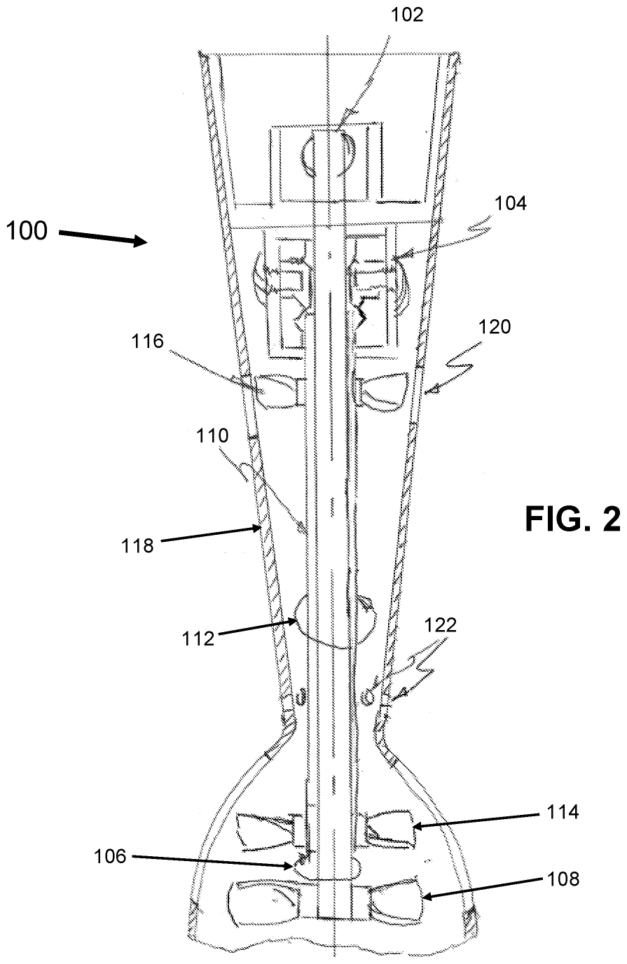

FIG. 2 illustrates a cross-sectional view of an exemplary embodiment of presently disclosed mixer technology. In particular, overall mixer system 100 does not show an explicit drive input, such as motor or rotational mechanism 12 (per FIG. 1), which may be practiced in accordance with presently disclosed subject matter, for controllably diving an exemplary represented input shaft 102. Input shaft 102 provides an input to a gearset 104, which may take various forms. For example, a differential gearset 104 such as with four bevel gears is represented. Other arrangements with similar functionality may be practiced, as referenced by herein referenced U.S. Pat. No. 9,839,884.

As represented in FIG. 2 to one of ordinary skill in the art, input shaft 102 may also pass through gearset 104 and directly turn in a rotational direction represented by circular arrow 106 in order to drive rotor with blades/impellers 108 in such direction.

As further illustrated, an output of gearset 104 drives an output shaft 110 in a rotational direction represented by circular arrow 112 in order to drive rotor with blades/impellers 114 in such direction. As will be understood, circular drive directions 106 and 112 are in opposite directions. In general, it is not significant for some embodiments which direction the respective rotor is driven, so long as the two rotors and blades/impellers 108/114 are rotationally driven in opposite directions.

As further shown, a pair or more of air impellers 116 are mounted in an arrangement to be rotated by the output shaft 110. It should be understood that the blades 116 are turned such that when shaft 110 is rotated in the direction of arrow 112, air from outside structure 118 is drawn into a represented pair of entry holes 120, and pushed downwardly within structure 118 so as to exit from a pair of exit holes 122. Those of ordinary skill in the art will appreciate that various numbers of both entry and exit holes, and their specific size and placement, may be varied in different embodiments of the presently disclosed subject matter, so long as downward air draft is created in relation the relative position of the cross-rotated rotors/blades/impellers 108 and 114.

As will be understood, the lower portion of structure 118 may be associated with a vessel for receiving materials to be mixed, resulting in efficient and effective aeration as well as mixing of materials/ingredients within the vessel.

Summarizing in another way, the presently disclosed subject matter in some embodiments includes an air impeller 116 (fan/propeller) secured to the outer rotating shaft 110 of a contra-rotating mechanism. A close-fitting housing 118 (or structure) encloses the contra-rotating mechanism and directs air (or other gas or liquid; fluid) downward. The housing 118 extends from the differential gearbox 104 to slightly above the two contra-rotating impellers 108 and 114. As shown, the housing 118 enclosing the gearbox 104 is adjacent a proximal end of the housing 118, and the housing 118 has a distal end extending towards the first and second rotors 108 and 114, respectively. Openings at the top of the housing 118 admits air which is forced to the bottom of the housing 118 by the air impellers 116 fastened to the outer shaft 110 of the contra-rotating mechanism.

Openings 122 in the lower portion of the housing 118 allows air to exit into the material (fluid or solid/liquid mixture). The air impeller 116 produces an air pressure at the lower exit openings 122 greater than the hydraulic pressure at the outer surfaces of the exit opening 122 of the housing 118. Thus, the contra-rotating impellers 108 and 114 of the mixer 100 distribute the exiting air into the material being aerated in a very uniform and efficient manner.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

What is claimed is:

1. A mixer apparatus configured to mix the contents of an associated vessel, the mixer apparatus comprising:
a rotational mechanism;
a gearbox attached to the rotational mechanism;
at least one shaft configured for rotation by the gearbox;
at least one rotor with at least one rotor blade, with the rotor arranged to be driven by the at least one shaft; and
a housing enclosing the gearbox adjacent a proximal end of the housing and having a distal end extending towards the at least one rotor,
wherein the housing has at least one entry opening for air to be drawn into the housing, and has at least one exit opening for aerated air to exit the housing.

2. The mixer apparatus according to claim 1, wherein
the at least one shaft comprises first and second shafts respectively attached to the gearbox with the gearbox configured to rotate the first and second shafts in respective opposite directions, and with the first and second shafts coaxial to each other;
the at least one rotor comprises a first rotor, comprising a plurality of first rotor blades, and configured to be rotated by the first shaft, and a second rotor, comprising a plurality of second rotor blades, and configured to be rotated by the second shaft; and
the housing distal end extends towards the first and second rotors.

3. The mixer apparatus according to claim 1, wherein the at least one entry opening is adjacent the gearbox.

4. The mixer apparatus according to claim 1, wherein the at least one exit opening is adjacent the rotors.

5. The mixer apparatus according to claim 1, wherein the at least one entry opening comprises a plurality of entry openings around the periphery of the housing.

6. The mixer apparatus according to claim 1, wherein the at least one exit opening comprises a plurality of exit openings around the periphery of the housing.

7. The mixer apparatus according to claim 2, further comprising at least a pair of additional air impellers attached to the outer of the two coaxial shafts, for rotation within the housing as the outer shaft is rotated.

8. The mixer apparatus according to claim 6, wherein the at least a pair of additional air impellers are located adjacent the at least one entry opening, so that as the impellers are rotated air is drawn into the housing through the at least one entry opening, and pushed along the interior of the housing and out the at least one exit opening thereof.

9. The mixer apparatus according to claim 2, further comprising:
at least a pair of additional air impellers, attached to the outer of the two coaxial shafts, for rotation within the housing as the outer shaft is rotated, and located adjacent the at least one entry opening;
wherein the at least one entry opening comprises a plurality of entry openings around the periphery of the housing and adjacent the gearbox;
the at least one exit opening comprises a plurality of exit openings around the periphery of the housing and adjacent the rotors; and
as the impellers are rotated, air is drawn into the housing through the at least one entry opening, and pushed along the interior of the housing and out the at least one exit opening thereof.

10. The mixer apparatus according to claim 1, wherein the rotational mechanism comprises a motor.

11. The mixer apparatus according to claim 2, wherein the first and second rotor blades are angled in respective directions.

12. The mixer apparatus according to claim 2, wherein the first rotor is rotated at substantially the same speed, but in an opposite direction, as the second rotor.

13. A mixer apparatus configured to mix the contents of an associated vessel, the mixer apparatus comprising:
a rotational mechanism;
a gearbox attached to the rotational mechanism;
first and second shafts respectively attached to the gearbox with the gearbox configured to rotate the first and second shafts in respective opposite directions, and with the first and second shafts coaxial to each other and with the first shaft located at least partially inside said second shaft to form paired inner and outer shafts;
a first rotor, comprising a plurality of first rotor blades, and configured to be rotated by the first shaft;
a second rotor, comprising a plurality of second rotor blades, and configured to be rotated by the second shaft;
a housing enclosing the gearbox adjacent a proximal end of the housing and having a distal end extending towards the first and second rotors;
a plurality of fluid entry openings formed in the periphery of the housing and adjacent the gearbox;
a plurality of fluid exit openings formed in the periphery of the housing and adjacent the rotors; and
at least a pair of fluid impellers, attached to the outer of the two coaxial shafts, for rotation within the housing as the outer shaft is rotated, and located adjacent the plurality of fluid entry openings so that as the impellers are rotated, fluid is drawn into the housing through at least one of the fluid entry openings, and pushed along the interior of the housing and out at least one of the fluid exit openings as aerated fluid.

14. The mixer apparatus according to claim 13, wherein the fluid comprises at least one of air or liquid mixtures.

15. The mixer apparatus according to claim 13, wherein the rotational mechanism comprises a motor.

16. The mixer apparatus according to claim 13, wherein the first and second rotor blades are angled in respective directions.

17. The mixer apparatus according to claim 13, wherein the first rotor is rotated at substantially the same speed, but in an opposite direction, as the second rotor.

18. Methodology for a mixer configured to mix the contents of an associated vessel, the methodology comprising:
providing a rotational mechanism;
providing at least one shaft configured for rotation by the rotational mechanism;
providing at least one rotor with at least one rotor blade, with the rotor arranged to be driven by the at least one shaft;
providing a housing enclosing a region adjacent a proximal end of the housing and having a distal end extending towards the at least one rotor;
providing the housing with at least one entry opening for air to be drawn into the housing, and with at least one exit opening for aerated air to exit the housing; and
controllably rotating the at least one shaft so that air is drawn into the housing through the at least one entry opening and aerated air is pushed out the at least one exit opening.

19. Methodology according to claim 18, wherein:
providing at least one shaft comprises providing first and second shafts configured to rotate the first and second shafts in respective opposite directions, and with the first and second shafts coaxial to each other; and
the rotational mechanism comprises respective direct drive motors, arranged for respectively rotating the first and second shafts in respective opposite directions.

20. Methodology according to claim 18, wherein:
the rotational mechanism drives an attached gearbox;
the at least one shaft is configured for rotation by the gearbox; and
the gearbox is received in the region enclosed by the housing.

21. Methodology according to claim 20, wherein:
providing at least one shaft comprises providing first and second shafts respectively attached to the gearbox with the gearbox configured to rotate the first and second shafts in respective opposite directions, and with the first and second shafts coaxial to each other;
providing at least one rotor comprises providing a first rotor, comprising a plurality of first rotor blades, and configured to be rotated by the first shaft, and comprises providing a second rotor, comprising a plurality of second rotor blades, and configured to be rotated by the second shaft; and
controllably rotating the at least one shaft comprises controllably rotating the first and second shafts in opposite directions so that air is drawn into the housing through the at least one entry opening and aerated air is pushed out the at least one exit opening.

22. Methodology according to claim 20, wherein the at least one entry opening is adjacent the gearbox, and the at least one exit opening is adjacent the rotors.

23. Methodology according to claim 20, wherein the at least one entry opening comprises a plurality of entry openings around the periphery of the housing, and the at least one exit opening comprises a plurality of exit openings around the periphery of the housing.

24. Methodology according to claim 21, further comprising providing at least a pair of additional air impellers attached to the outer of the two coaxial shafts and located adjacent the at least one entry opening, for rotation within the housing as the outer shaft is rotated.

25. Methodology according to claim 21, wherein the first and second rotor blades are angled in respective directions.

26. Methodology according to claim 21, wherein the first rotor is rotated at substantially the same speed, but in an opposite direction, as the second rotor.
